(19) United States
(12) Patent Application Publication
(10) Pub. No.: US 2021/0027750 A1
(43) Pub. Date: Jan. 28, 2021

(54) DISPLAY APPARATUS, DISPLAY SYSTEM, AND DISPLAY METHOD

(71) Applicant: ATSUSHI KOKUBO, KANAGAWA (JP)

(72) Inventor: ATSUSHI KOKUBO, KANAGAWA (JP)

(73) Assignee: Ricoh Company, Ltd., Tokyo (JP)

(21) Appl. No.: 16/893,700

(22) Filed: Jun. 5, 2020

(30) Foreign Application Priority Data
Jul. 25, 2019 (JP) 2019-136954

(51) Int. Cl. G09G 5/38; G09G 5/373; G06F 3/14

(52) U.S. Cl. CPC G09G 5/38; G09G 5/373; G09G 2370/02; G09G 2340/0464; G06F 3/1454

(57) ABSTRACT

A display apparatus includes circuitry that, in response to receipt of a display request to display an object on a display of the display apparatus, determines whether the object to be displayed on the display will overlap information already displayed on the display. When it is determined that the object to be displayed on the display will overlap the information already displayed on the display, the circuitry corrects a display position of the object in the display.

### CROSS-REFERENCE TO RELATED APPLICATION

This patent application is based on and claims priority pursuant to 35 U.S.C. § 119(a) to Japanese Patent Application No. 2019-136954 filed on Jul. 25, 2019 in the Japan Patent Office, the entire disclosure of which is hereby incorporated by reference herein.

### BACKGROUND

### Technical Field

The present invention relates to a display apparatus, a display system, and a display method.

### Description of the Related Art

In recent years, an electronic whiteboard has been used which displays a background image on a large display to enable a user to render a stroke image of a letter, character, number, or figure, for example, on the background image. Further, a technique has been used in recent years which connects a plurality of electronic whiteboards at a plurality of sites via a network such that the electronic whiteboards share information such as images and text.

According to this technique, when one of the electronic whiteboards at one of the sites receives a user operation, the electronic whiteboard transmits operation content notification information to the other electronic whiteboards at the other sites to notify the other electronic whiteboards of the received user operation. Thereby, users at the other sites are informed in advance of the user operation performed at the one of the sites. Consequently, the technique keeps the users at the other sites from performing an operation inconsistent with the user operation performed at the one of the sites.

According to the technique, however, the users at the other sites may not recognize the contents of the operation performed at the one of the sites or what is being displayed at the site. In this case, there may arise inconsistency between the user operation at the site and the user operations at the other sites, which may degrade the visibility of display contents.

### SUMMARY

In one embodiment of this invention, there is provided an improved display apparatus that includes circuitry, for example. In response to receipt of a display request to display an object on a display of the display apparatus, the circuitry determines whether the object to be displayed on the display will overlap information already displayed on the display. When it is determined that the object to be displayed on the display will overlap the information already displayed on the display, the circuitry corrects a display position of the object in the display.

In one embodiment of this invention, there is provided an improved display system that includes, for example, a terminal apparatus and a display apparatus. The display apparatus includes circuitry. In response to receipt, from the terminal apparatus, of a display request to display an object on a display of the display apparatus, the circuitry determines a display position of the object in the display, and calculates a size of a display area of the object in the display. When there is infottiiation already displayed on the display and the display has an area in which overlapping of the object and the information is avoided, the circuitry determines a position of the display area of the object in the area. When there is information already displayed on the display and the display lacks the area in which the overlapping of the object and the information is avoided, the circuitry corrects the size of the display area of the object.

In one embodiment of this invention, there is provided an improved display method that includes, for example, determining, in response to receipt of a display request to display an object on a display, whether the object to be displayed on the display will overlap information already displayed on the display, and when the determining determines that the object to be displayed on the display will overlap the information already displayed on the display, correcting a display position of the object in the display.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of the system configuration of a display system of a first embodiment of the present invention;

FIG. 2 is a diagram illustrating an electronic whiteboard included in the display system of the first embodiment;

FIG. 3 is a diagram illustrating an example of the hardware configuration of a management apparatus included in the display system of the first embodiment;

FIG. 4 is a diagram illustrating an example of the hardware configuration of the electronic whiteboard of the first embodiment;

FIG. 5 is a diagram illustrating respective functional configurations of the electronic whiteboard and the management apparatus of the first embodiment;

FIGS. 6A and 6B are diagrams illustrating an object of the first embodiment;

FIG. 7 is a diagram illustrating an object storing unit of the electronic whiteboard of the first embodiment;

FIG. 8 is a sequence diagram illustrating an operation of the display system of the first embodiment;

FIG. 9 is a diagram illustrating an example of display by the management apparatus of the first embodiment;

FIGS. 10A and 10B are diagrams illustrating other examples of the display by the management apparatus of the first embodiment;

FIGS. 11A, 11B, 11C, and 11D are diagrams illustrating examples of a hypertext transfer protocol (HTTP) request and an HTTP response transmitted between the management apparatus and the electronic whiteboard of the first embodiment;

FIGS. 12A and 12B are diagrams illustrating other examples of the HTTP request and the HTTP response transmitted between the management apparatus and the electronic whiteboard of the first embodiment;

FIG. 13 is a flowchart illustrating a process of the electronic whiteboard of the first embodiment;

FIGS. 14A and 14B are diagrams illustrating an example of correction by a correction unit of the electronic whiteboard of the first embodiment;

FIGS. 15A, 15B, and 15C are diagrams illustrating other examples of the correction by the correction unit of the electronic whiteboard of the first embodiment;

FIGS. 16A, 16B, and 16C are diagrams illustrating still other examples of the correction by the correction unit of the electronic whiteboard of the first embodiment;

FIG. 17 is a diagram illustrating an example of the system configuration of a display system of a second embodiment of the present invention;

FIG. 18 is a diagram illustrating functions of an electronic whiteboard included in the display system of the second embodiment;

FIG. 19 is a sequence diagram illustrating an operation of the display system of the second embodiment;

FIG. 20 is a flowchart illustrating a process of the electronic whiteboard of the second embodiment;

FIG. 21 is a diagram illustrating an example of display by a terminal apparatus included in the display system of the second embodiment;

FIG. 22 is a diagram illustrating another example of the display by the terminal apparatus of the second embodiment;

FIG. 23 is a diagram illustrating another example of the system configuration of the display system of the first embodiment;

FIG. 24 is a diagram illustrating another example of the system configuration of the display system of the second embodiment;

FIG. 25 is a diagram illustrating a modified example of the display system in FIG. 24;

FIG. 26 is a diagram illustrating another modified example of the display system in FIG. 24; and

FIG. 27 is a diagram illustrating still another modified example of the display system in FIG. 24.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present invention will be described below with the drawings.

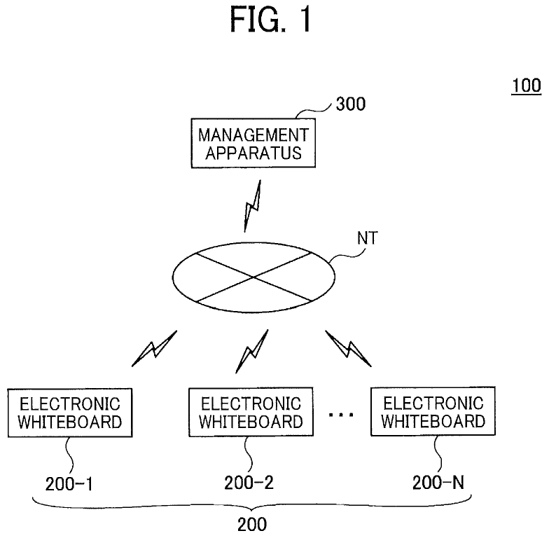

FIG. 1 is a diagram illustrating an example of the system configuration of a display system 100 of a first embodiment of the present invention.

The display system 100 of the first embodiment includes a management apparatus 300 and electronic whiteboards 200-1, 200-2, . . . , and 200-N. Herein, N represents an integer equal to or greater than 3. In the display system 100, the electronic whiteboards 200-1 to 200-N and the management apparatus 300 are connected to each other via a network NT. In the following description, each of the electronic whiteboards 200-1 to 200-N will be simply referred to as the electronic whiteboard 200 where distinction therebetween is unnecessary.

The electronic whiteboard 200 and the management apparatus 300 communicate with each other with a world wide web application programming interface (WebAPI). The WebAPI is an API implemented by a Web technology based on a protocol such as hypertext transfer protocol (HTTP). To use a function provided by a certain program, the WebAPI is used to invoke the function from another external program.

In response to receipt of an HTTP request transmitted from the management apparatus 300 via the network NT, for example, the electronic whiteboard 200 of the first embodiment transmits a processing result to the management apparatus 300 as an HTTP response. That is, the electronic whiteboard 200 and the management apparatus 300 of the first embodiment serve as a server apparatus and a client apparatus, respectively. The WebAPI is typically implemented as a representational state transfer (REST) API or a simple object access protocol (SOAP) API.

As an application example of the display system 100 of the first embodiment, the display system 100 of the first embodiment may be used in a factory, in which the electronic whiteboards 200 are installed in respective work spaces to be used by operators who work in the work spaces.

The management apparatus 300 of the first embodiment is operated by, for example, an administrator who manages the operations in the work spaces. Specifically, when information to be notified to the operators is input to the management apparatus 300 by the administrator, for example, the information is transmitted to the electronic whiteboards 200-1 to 200-N.

In response to receipt of the information, each of the electronic whiteboards 200-1 to 200-N (i.e., the electronic whiteboard 200) displays the received information at a position on the electronic whiteboard 200 at which the received information will not overlap other information already displayed on the electronic whiteboard 200.

Specifically, when the administrator issues an instruction to stop the operation to all operators in the work spaces, for example, the administrator simultaneously transmits information representing the instruction to stop the operation from the management apparatus 300 to the electronic whiteboards 200-1 to 200-N.

It is assumed here, for example, that information related to the operation is already displayed on the electronic whiteboard 200-1, that handwritten text is being input to the electronic whiteboard 200-2 by an operator, and that no information is displayed on the electronic whiteboard 200-N.

In this case, in response to receipt of the information of the instruction to stop the operation, the electronic whiteboard 200-1 determines the display position of the received information such that the received information will not overlap the already displayed information.

Further, the electronic whiteboard 200-2 displays the information of the instruction to stop the operation at a position at which the information of the instruction will not overlap the handwritten text, which is currently being input.

Further, the electronic whiteboard 200-N displays the information of the instruction to stop the operation in accordance with position information included in the information of the instruction.

The display system 100 of the first embodiment therefore obviates the need for the administrator to check the state of each of the electronic whiteboards 200 when transmitting information to the electronic whiteboards 200 from the management apparatus 300. Consequently, the information intended to be notified to the electronic whiteboards 200 is easily displayed on the electronic whiteboards 200.

Further, the display system 100 of the first embodiment prevents overlap of the information already displayed on the electronic whiteboard 200 and the information input from the management apparatus 300, thereby improving the visibility of information.

In the above description, the state of each of the electronic whiteboards 200 represents whether there is any information already displayed on the electronic whiteboard 200, the display position of the already displayed information, and whether there is any operation being performed on the electronic whiteboard 200, for example.

The above-described application example of the display system 100 of the first embodiment is illustrative. Thus, the application of the display system 100 of the first embodiment is not limited thereto. The display system 100 of the first embodiment is therefore applicable to any other situation in which the information to be displayed on the electronic whiteboards 200 is transmitted to the electronic whiteboards 200 without checking of the state of each of the electronic whiteboards 200.

Further, although the information is transmitted from the management apparatus 300 to the electronic whiteboards 200 in the example of FIG. 1, the transmission of information is not limited thereto. In the display system 100 of the first embodiment, information may be transmitted from one of the plurality of electronic whiteboards 200 to another one of the plurality of electronic whiteboards 200. In this case, in response to receipt of the information from the one of the plurality of electronic whiteboards 200, the another one of the plurality of electronic whiteboards 200 performs display control similar to that performed in response to receipt of information from the management apparatus 300.

Specifically, for example, information input to the electronic whiteboard 200-1 may be simultaneously transmitted to the electronic whiteboards 200-2 to 200-N. In this case, each of the electronic whiteboards 200-2 to 200-N displays the received information at a position at which the received information will not overlap other information.

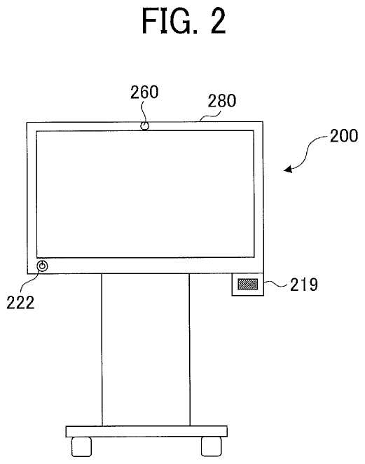

The electronic whiteboard 200 of the first embodiment will be described with FIG. 2.

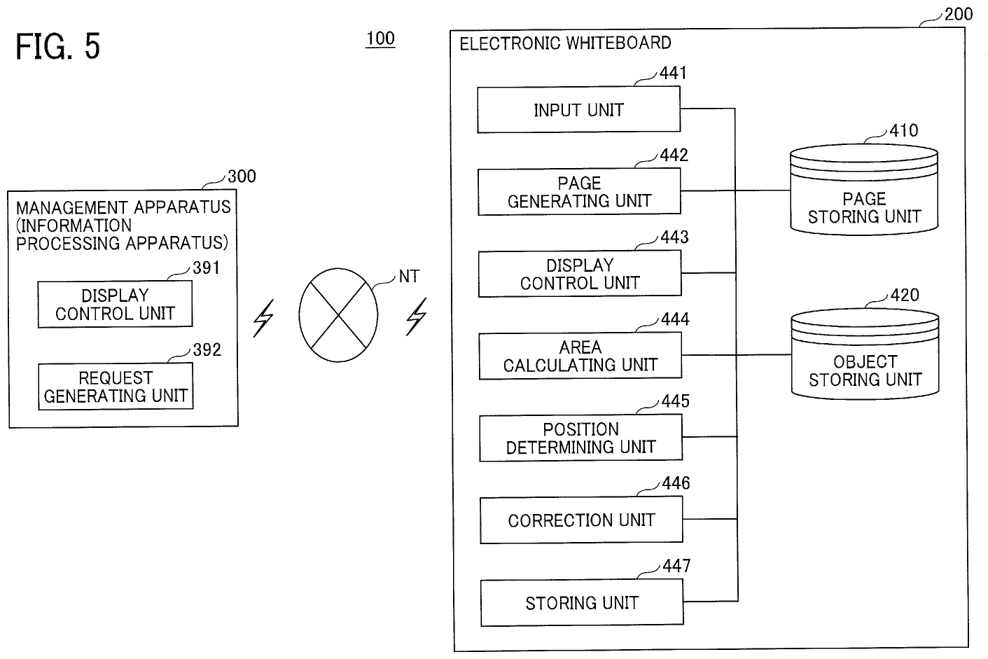

FIG. 2 is a diagram illustrating the electronic whiteboard 200 of the first embodiment. The electronic whiteboard 200 of the first embodiment includes a near field communication circuit 219, a power switch 222, a display 280, and a camera 260. In response to pressing of the power switch 222, a later-described display control unit 443 (see FIG. 5) of the electronic whiteboard 200 controls the display 280 to display a rendering screen on which a user performs rendering with an electronic pen or a finger of the user. Therefore, the ecteronic whiteboard 200 is an example of a display apparatus, and the display 280 is an example of a display of the display apparatus.

The respective apparatuses included in the display system 100 of the first embodiment will be described.

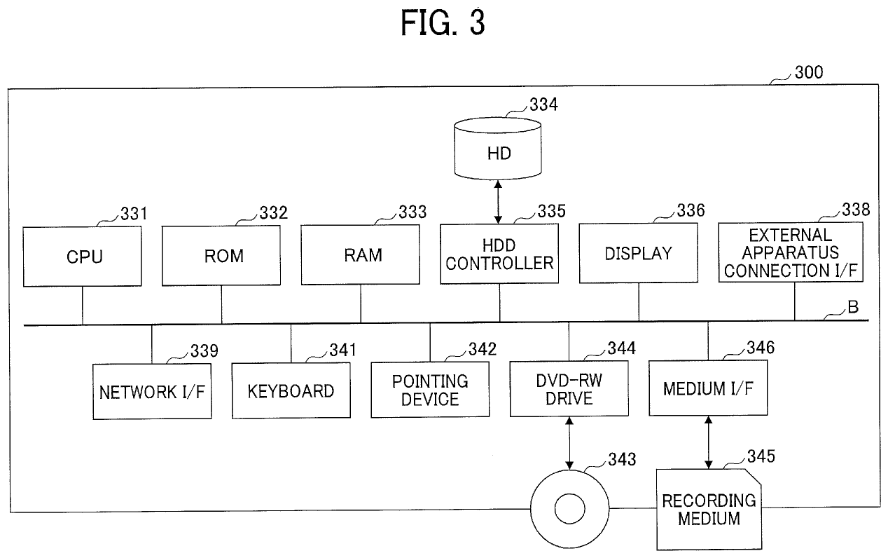

FIG. 3 is a diagram illustrating an example of the hardware configuration of the management apparatus 300 of the first embodiment. The management apparatus 300 of the first embodiment is implemented by a computer. As illustrated in FIG. 3, the management apparatus 300 is an information processing apparatus including a central processing unit (CPU) 331, a read only memory (ROM) 332, a random access memory (RAM) 333, a hard disk (HD) 334, a hard disk drive (HDD) controller 335, a display 336, an external apparatus connection interface (I/F) 338, a network I/F 339, a data bus B, a keyboard 341, a pointing device 342, a digital versatile disk rewritable (DVD-RW) drive 344, a medium I/F 346, and a bus line B.

The CPU 331 controls an overall operation of the management apparatus 300. The ROM 332 stores a program used to drive the CPU 331 such as an initial program loader (IPL). The RAM 333 is used as a work area for the CPU 331. The HD 334 stores various data of a program, for example. The HDD controller 335 controls writing and reading of various data to and from the HD 334 under the control of the CPU 331. The display 336 displays various information such as a cursor, menus, windows, text, and images. The external apparatus connection I/F 338 is an interface for connecting the management apparatus 300 to various external apparatuses. The external apparatuses in this case include a universal serial bus (USB) memory and a printer, for example. The network I/F 339 is an interface for performing data communication via the network NT. The bus line B includes address buses and data buses to electrically connect the CPU 331 and the other components in FIG. 3 to each other.

The keyboard 341 is an input device including a plurality of keys for inputting text, numerical values, and various instructions, for example. The pointing device 342 is an input device used to select and execute various instructions, select a processing target, and move the cursor, for example. The DVD-RW drive 344 controls writing and reading of various data to and from a DVD-RW 343 as an example of a recording medium removable from the management apparatus 300. The recording medium removable from the management apparatus 300 is not limited to the DVD-RW, and may be a DVD-recordable (DVD-R), for example. The medium I/F 346 controls writing (i.e., storage) and reading of data to and from a recording medium 345 such as a flash memory.

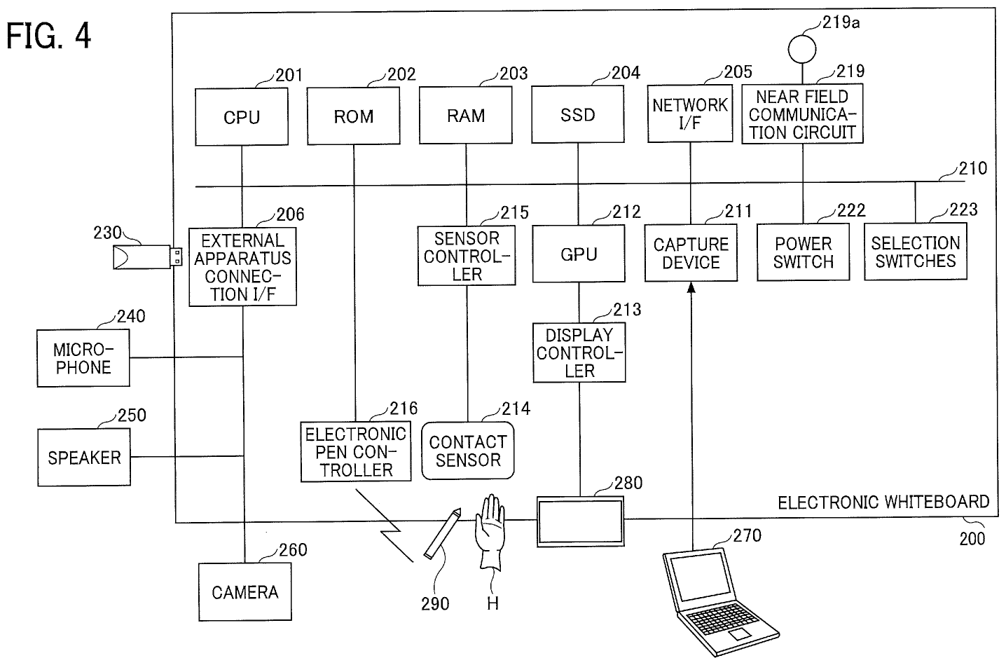

A hardware configuration of the electronic whiteboard 200 of the first embodiment will be described with FIG. 4.

FIG. 4 is a diagram illustrating an example of the hardware configuration of the electronic whiteboard 200 of the first embodiment. As illustrated in FIG. 4, the electronic whiteboard 200 includes a CPU 201, a ROM 202, a RAM 203, a solid state drive (SSD) 204, a network I/F 205, and an external apparatus connection I/F 206.

The CPU 201 controls an overall operation of the electronic whiteboard 200. The ROM 202 stores a program used to drive the CPU 201 such as the IPL. The RAM 203 is used as a work area for the CPU 201. The SSD 204 stores various data of a program for the electronic whiteboard 200.

The network I/F 205 controls communication of the electronic whiteboard 200 with a communication network such as the network NT. The external apparatus connection I/F 206 is an interface for connecting the electronic whiteboard 200 to various external apparatuses. The external apparatuses in this case include a USB memory 230 and external apparatuses such as a microphone 240, a speaker 250, and the camera 260, for example.

The electronic whiteboard 200 further includes a capture device 211, a graphics processing unit (GPU) 212, a display controller 213, a contact sensor 214, a sensor controller 215, an electronic pen controller 216, the near field communication circuit 219, an antenna 219a for the near field communication circuit 219, the power switch 222, selection switches 223, and a bus line 210.

The capture device 211 controls a display of an external personal computer (PC) 270 to display image information as a still or video image. The GPU 212 is a semiconductor chip processor dedicated to graphics processing. The GPU 212 may be built in or integrated with the CPU 201.

The display controller 213 controls and manages screen display to output an image from the GPU 212 to the display 280, for example. The contact sensor 214 detects the contact of an electronic pen 290 or a hand H of a user on the display 280. The sensor controller 215 controls the processing of the contact sensor 214.

The contact sensor 214 performs input and detection of coordinates in accordance with an infrared blocking method. In this method of inputting and detecting coordinates, two light receiving devices disposed on opposite end portions of an upper area of the display 280 radiate a plurality of infrared rays parallel to the display 280, and receive rays of light reflected by a reflecting member disposed around the display 280 and returning on optical paths of the rays radiated by the two light receiving devices. The contact sensor 214 outputs, to the sensor controller 215, identifiers (IDs) of the infrared rays radiated by the two light receiving devices and blocked by an object. Then, the sensor controller 215 identifies the position of the coordinates corresponding to the position of contact of the object on the display 280.

The electronic pen controller 216 communicates with the electronic pen 290 to determine contact or non-contact of the head or end of the electronic pen 290 on the display 280. The near field communication circuit 219 is a communication circuit conforming to a standard such as the near field communication (NFC) or Bluetooth (registered trademark) standard. The power switch 222 is a switch for switching on or off power supply to the electronic whiteboard 200. The selection switches 223 are switches for adjusting parameters such as the brightness and the color tone of the display 280, for example. The bus line 210 includes address buses and data buses to electrically connect the CPU 201 and the other components in FIG. 4 to each other.

The contact sensor 214 is not limited to the infrared blocking method, and may employ a different type of detecting device, such as a capacitance touch panel that identifies the contact position by detecting a change in capacitance, a resistive touch panel that identifies the contact position by detecting a change in voltage of two resistance films facing each other, or an electromagnetic induction touch panel that identifies the contact position by detecting electromagnetic induction caused by contact of an object on a display. Further, the electronic pen controller 216 may determine contact or non-contact of a part of the electronic pen 290 held by the user or another part of the electronic pen 290, as well as the head or end of the electronic pen 290.

Further, in the first embodiment, the camera 260 is an example of a proximity sensor that detects approach of the electronic pen 290 or the hand H to the display 280. Alternatively, the electronic whiteboard 200 may include a projected capacitive touch panel or an infrared sensor as the proximity sensor.

Respective functional configurations of the electronic whiteboard 200 and the management apparatus 300 of the first embodiment will be described with FIG. 5.

FIG. 5 is a diagram illustrating respective functional configurations of the electronic whiteboard 200 and the management apparatus 300 of the first embodiment.

The management apparatus 300 of the first embodiment includes a display control unit 391 and a request generating unit 392. Each of the display control unit 391 and the request generating unit 392 is a function or functional unit implemented when at least one of the components illustrated in FIG. 3 operates in response to a command from the CPU 331 in accordance with the program deployed on the RAM 333 from the HD 334.

The display control unit 391 controls display on the display 336 of the management apparatus 300. When the data to be transmitted to the electronic whiteboard 200 is selected on a screen displayed on the display 336 by the display control unit 391, the request generating unit 392 generates an HTTP request including object information of an object including the data. The generated HTTP request is transmitted to the electronic whiteboard 200, for example.

The electronic whiteboard 200 of the first embodiment includes a page storing unit 410, an object storing unit 420, an input unit 441, a page generating unit 442, the display control unit 443, an area calculating unit 444, a position determining unit 445, a correction unit 446, and a storing unit 447.

The page storing unit 410 and the object storing unit 420 of the electronic whiteboard 200 of the first embodiment are implemented by the RAM 203, the SSD 204, or the USB memory 230, for example. Each of the input unit 441, the page generating unit 442, the display control unit 443, the area calculating unit 444, the position determining unit 445, and the correction unit 446 of the electronic whiteboard 200 of the first embodiment is a function or functional unit implemented when at least one of the components illustrated in FIG. 4 operates in response to a command from the CPU 201 in accordance with the program deployed on the RAM 203 from the SSD 204.

The page storing unit 410 stores page data displayed on the display 280 of the electronic whiteboard 200. The page data stored in the page storing unit 410 may be stroke image data representing a stroke image rendered on the display 280 or image data acquired from outside the electronic whiteboard 200, for example.

The stroke image is the image of the trajectory of one handwritten stroke input to the display 280 of the electronic whiteboard 200 with the electronic pen 290 or a finger of the user, for example.

The page data may also be the image data of a superimposed image in which an image displayed on the display 280 and a stroke image input to the display 280 are superimposed upon each other.

The object storing unit 420 stores the object information of the object. Specifically, the image of a particular rectangular area representing the data input to the electronic whiteboard 200 is stored in the object storing unit 420 as the object. The data input to the electronic whiteboard 200 may be text data, image data, or stroke image data representing a stroke image rendered on the display 280, for example.

That is, the object is the image of the rectangular area. Further, position information representing the position of a reference point of the object displayed on the display 280 as the rectangular area is held in the object storing unit 420. The object storing unit 420 will be described in detail later.

The input unit 441 acquires the image data of the stroke image representing a handwritten letter or image input to the display 280 and the image displayed on a touch panel disposed on the display 280.

The input unit 441 further acquires video data of video image captured by the camera 260. In the first embodiment, the video data is included in the image data. The input unit 441 further receives various instructions input to the electronic whiteboard 200. The input unit 441 further acquires input image data, i.e., image data input to the electronic whiteboard 200 from the PC 270, for example.

The page generating unit 442 acquires the image data of one page of image (i.e., display image) displayed on the display 280. If a stroke image is input to the one page of image, the page generating unit 442 further acquires the stroke image data representing the stroke image.

Specifically, the page generating unit 442 acquires the image data of a superimposed image in which images such as an input image input to the display 280 and a stroke image are superimposed upon each other, and the page generating unit 442 stores the acquired image data in the page storing unit 410. When there is no stroke image input to the display 280, the page generating unit 442 determines the data of the image displayed on the display 280 as the image data.

If a stroke image is input to the display 280, the page generating unit 442 further stores the stroke image data representing the stroke image in the page storing unit 410 as the image data.

The display control unit 443 controls the display 280 to display various information. Specifically, for example, the display control unit 443 controls the display 280 to display the object based on the object information input to the electronic whiteboard 200.

Based on the position information included in the object information, the area calculating unit 444 calculates the display area of the object in the display 280, i.e., the display area for displaying the object on the display 280.

The position determining unit 445 determines whether there is an image already displayed in the display area calculated by the area calculating unit 444. If the position determining unit 445 determines that there is no image already displayed in the display area, the position determining unit 445 determines the position of the display area as the display position of the object. If the position determining unit 445 determines that there is an image already displayed in the display area, the correction unit 446 corrects the display position of the object. That is, the position determining unit 445 of the first embodiment determines whether the object to be displayed on the display 280 will be superimposed on the information already displayed on the display 280.

In accordance with the result of determination by the position determining unit 445, the correction unit 446 corrects the display position of the object. The processing of the correction unit 446 will be described in detail later.

The storing unit 447 extracts the object information of the object from the HTTP request received from the management apparatus 300, and stores the extracted object information in the object storing unit 420.

Each of the display control unit 443, the area calculating unit 444, the position deteimining unit 445, the correction unit 446, and the storing unit 447 may be a function invoked by the electronic whiteboard 200 in response to the HTTP request from the management apparatus 300.

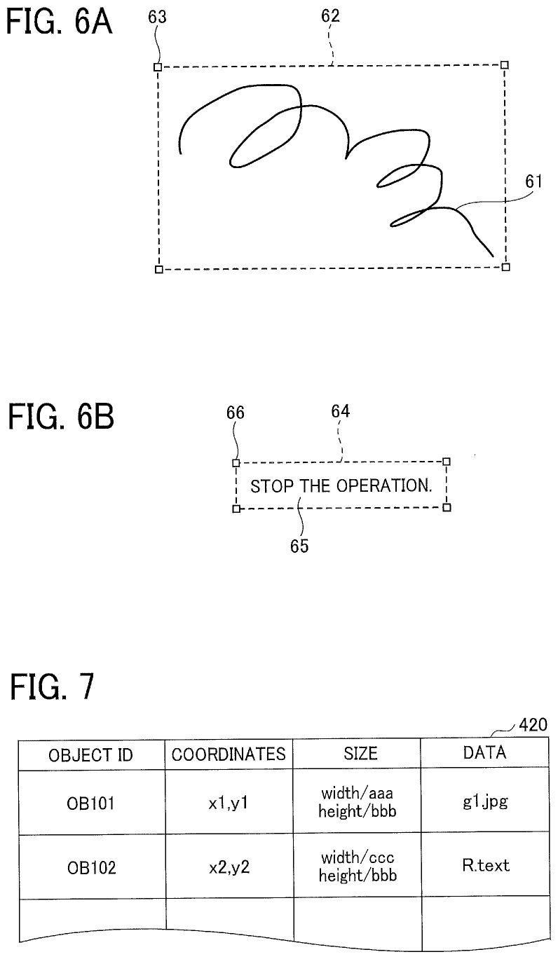

The object and the object storing unit 420 of the first embodiment will be described with FIGS. 6A and 6B and FIG. 7.

FIGS. 6A and 6B are diagrams illustrating the object of the first embodiment. An object 62 illustrated in FIG. 6A is the image of a rectangular area including a stroke image 61. The object information of the object 62 of the first embodiment includes the stroke image data representing the stroke image 61 and the position information representing the position of the reference point of the rectangular area enclosing the stroke image 61. In the example of FIG. 6A, the reference point corresponds to an upper-left vertex 63 of the rectangular area enclosing the stroke image 61.

An object 64 illustrated in FIG. 6B is the image of a rectangular area including text 65. The object information of the object 64 of the first embodiment includes the text data representing the text 65 and the position information representing the position of the reference point of the rectangular area enclosing the text 65. In the example of FIG. 6B, the reference point corresponds to an upper-left vertex 66 of the rectangular area enclosing the text 65.

FIG. 7 is a diagram illustrating the object storing unit 420 of the electronic whiteboard 200 of the first embodiment. The object information stored in the object storing unit 420 of the electronic whiteboard 200 of the first embodiment includes information items: “object ID,” “coordinates,” “size,” and “data.”

The value of the information item “object ID” represents identification information for identifying the corresponding object. For example, the object ID may be assigned to the object when the electronic whiteboard 200 receives the object information of the object. The value of the information item “coordinates” represents coordinates representing the position of the reference point of the object in the display 280. The value of the information item “size” represents the size of the object. The value of the information item “data” represents the data included in the rectangular area.

The example of FIG. 7 indicates that coordinates (x1, y1) represent the position in the display 280 of the reference point of an object identified by an object ID “OB101,” that the data of the object is image data labeled “g1.jpeg,” and that the size of the object as measured from the reference point is represented as a width aaa and a height bbb.

The example of FIG. 7 further indicates that coordinates (x2, y2) represent the position in the display 280 of the reference point of an object identified by an object ID “OB102,” that the data of the object is text data labeled “R.text,” and that the size of the object as measured from the reference point is represented as a width ccc and the height bbb.

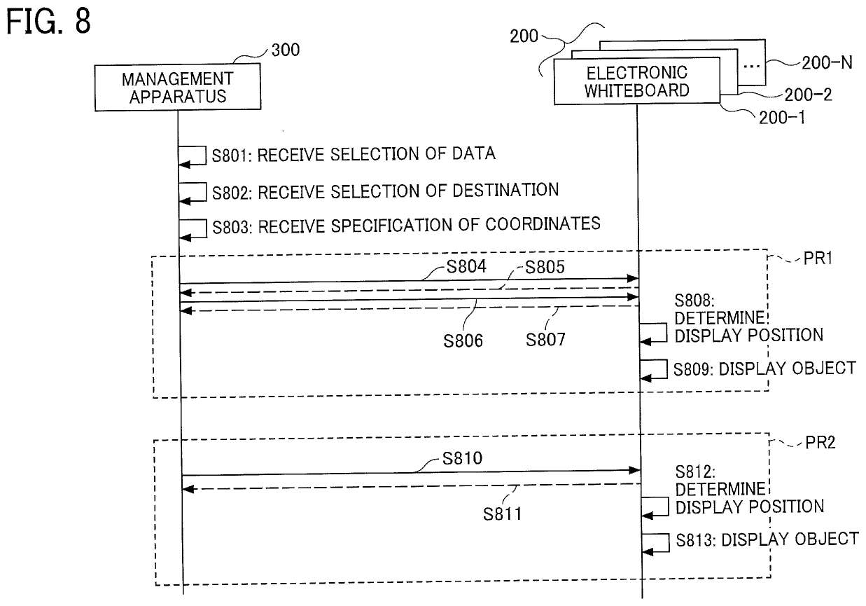

An operation of the display system 100 of the first embodiment will be described with FIG. 8.

FIG. 8 is a sequence diagram illustrating an operation of the display system 100 of the first embodiment. In the display system 100 of the first embodiment, the management apparatus 300 receives the selection of the data to be transmitted (step S801), and receives the selection of the destination apparatus to which the data is to be transmitted (step S802).

The following description will be given of an example in which a plurality of electronic whiteboards 200 including the electronic whiteboards 200-1 to 200-N are selected as the destination apparatuses to which the data is to be transmitted.

Then, the management apparatus 300 receives the specification of the coordinates representing the reference point of the object including the selected data (step S803).

The management apparatus 300 then transmits to each of the selected destination apparatuses an HTTP request that requests the display of the object. In other words, the management apparatus 300 transmits to the selected destination apparatus a display request that requests the display of the object.

If the data selected at step S801 is the image data, the display system 100 executes an operation illustrated as a process PR1. If the data selected at step S801 is the text data, the display system 100 executes an operation illustrated as a process PR2.

If the data selected at step S801 is the image data, the request generating unit 392 of the management apparatus 300 generates an HTTP request including the selected image data, the coordinates of the reference point of the object including the image data, and the size of the object. Then, the management apparatus 300 transmits the generated HTTP request to each of the electronic whiteboards 200 (step S804).

In response to receipt of the HTTP request, the electronic whiteboard 200 transmits an HT IP response to the management apparatus 300 as a response to the HTTP request (step S805). Herein, the HTTP response includes the uniform resource identifier (URI) of the upload destination of the object.

In response to receipt of the HTTP response, the management apparatus 300 generates an HTTP request that requests the upload of the image data included in the object, and transmits the generated HTTP request to the electronic whiteboard 200 (step S806). In response to receipt of the HTTP request, the electronic whiteboard 200 transmits to the management apparatus 300 an HTTP response representing a processing result (step S807).

In this step, the storing unit 447 of the electronic whiteboard 200 may acquire the image data, the coordinates of the reference point of the object, and the size of the object from the HTTP request, and may store the image data, the coordinates, and the size in the object storing unit 420 as the object information.

Then, in the electronic whiteboard 200, the functions of the area calculating unit 444, the position determining unit 445, and the correction unit 446 are invoked by a command from the CPU 201 in accordance with the program deployed on the RAM 203, and execute the respective processes.

Specifically, with functional units such as the area calculating unit 444, the position determining unit 445, and the correction unit 446, the electronic whiteboard 200 determines the display position of the object in the display 280 (step S808). The process of step S808 will be described in detail later.

Then, the electronic whiteboard 200 displays the object at the determined display position (step S809).

If the data selected at step S801 is the text data, on the other hand, the request generating unit 392 of the management apparatus 300 generates an HTTP request including the text data, the coordinates of the reference point of the object including the text data, and the size of the object. The management apparatus 300 then transmits the generated HTTP request to the electronic whiteboard 200 (step S810).

In response to receipt of the HT IP request, the electronic whiteboard 200 transmits an HTTP response to the management apparatus 300 as a processing result (step S811). In this step, the storing unit 447 of the electronic whiteboard 200 may acquire the text data, the coordinates of the reference point of the object, and the size of the object from the HTTP request, and may store the text data, the coordinates, and the size in the object storing unit 420 as the object information.

Further, in the electronic whiteboard 200, in response to receipt of the HTTP request, the functions of the area calculating unit 444, the position determining unit 445, and the correction unit 446 are invoked by a command from the CPU 201 in accordance with the program deployed on the RAM 203, and execute the respective processes. The processes of steps S812 and 813 are similar to those of steps 5808 and 809, and thus description thereof will be omitted.

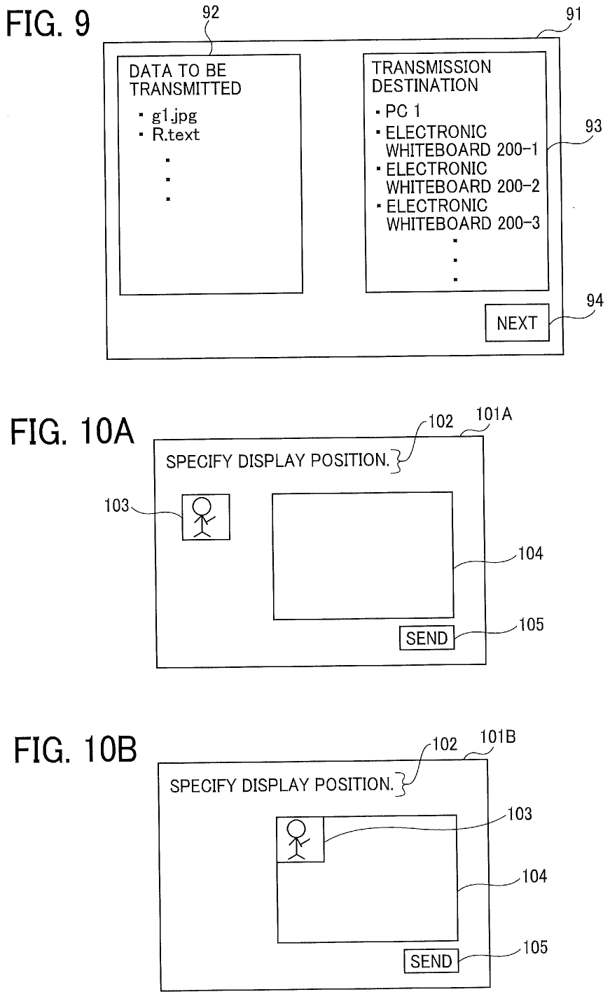

The selection of the data, the selection of the destination apparatus to which the data is to be transmitted, and the specification of the display position of the object in the management apparatus 300 will be described with FIG. 9 and FIGS. 10A and 10B.

FIG. 9 is a diagram illustrating an example of display by the management apparatus 300 of the first embodiment. A screen 91 illustrated in FIG. 9 is displayed on the display 336 by the display control unit 391 of the management apparatus 300, for example.

The screen 91 includes display fields 92 and 93 and an operation button 94. The display field 92 displays a list of data items, and the display field 93 displays a list of destination apparatuses.

In the management apparatus 300, a data item is selected from the display field 92, and a destination apparatus is selected from the display field 93. Then, in response to receipt of an operation performed on the operation button 94, the screen 91 transitions to a screen 101A in FIG. 10A.

It is assumed here that the data labeled “gl.jpg” is selected from the display field 92 as the data to be transmitted, and that the electronic whiteboards 200-1 to 200-N are selected from the display field 93 as the destination apparatuses.

FIGS. 10A and 10B are diagrams illustrating other examples of the display by the management apparatus 300 of the first embodiment. The screen 101A illustrated in FIG. 10A is displayed on the display 336 of the management apparatus 300 when the operation button 94 on the screen 91 is operated.

The screen 101A displays a message 102, an object 103, an image 104, and an operation button 105. The object 103 includes the selected data. The message 102 prompts the user to specify the display position of the object 103 including the selected data. The image 104 represents the outline of the display 280.

In the first embodiment, the object 103 is moved onto the image 104 in the screen 101A through an operation such as drag-and-drop. Thereby, the coordinates representing the position of the object 103 in the image 104 are acquired as the position information representing the position of the reference point of the object 103 when the object 103 is displayed on the display 280.

On a screen 101B illustrated in FIG. 10B, the object 103 is moved onto the image 104. In this case, the upper-left vertex of the object 103 is superimposed on the upper-left vertex of the image 104.

The management apparatus 300 therefore determines the value of the information item “coordinates” included in the object information of the object 103 as the coordinates representing the position of the upper-left vertex of the display 280.

In the first embodiment, when the operation button 105 on the screen 101B is operated, an HT IP request including the object information of the object 103 is generated and transmitted from the management apparatus 300 to each of the electronic whiteboards 200-1 to 200-N.

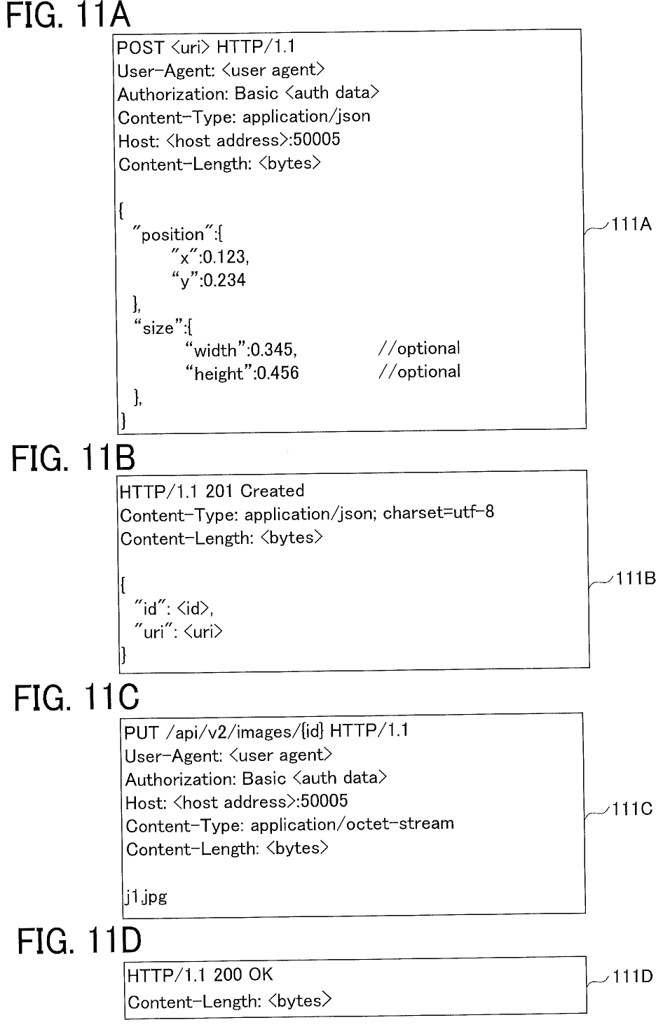

FIGS. 11A, 11B, 11C, and 11D are diagrams illustrating examples of the HTTP request and the HTTP response transmitted between the management apparatus 300 and the electronic whiteboard 200.

FIG. 11A illustrates a description 111A corresponding to an HTTP request transmitted from the management apparatus 300 to the electronic whiteboard 200 at step S804. FIG. 11B illustrates a description 111B corresponding to an HTTP response transmitted from the electronic whiteboard 200 to the management apparatus 300 at step S805 in response to receipt of the HTTP request.

FIG. 11C illustrates a description 111C corresponding to an HTTP request transmitted from the management apparatus 300 to the electronic whiteboard 200 at step S806. FIG. 11D illustrates a description 111D corresponding to an HTTP response transmitted from the electronic whiteboard 200 to the management apparatus 300 at step S807 in response to receipt of the HTTP request.

The description 111A includes the coordinates and the size included in the object information. The description 111C includes the image data included in the object information.

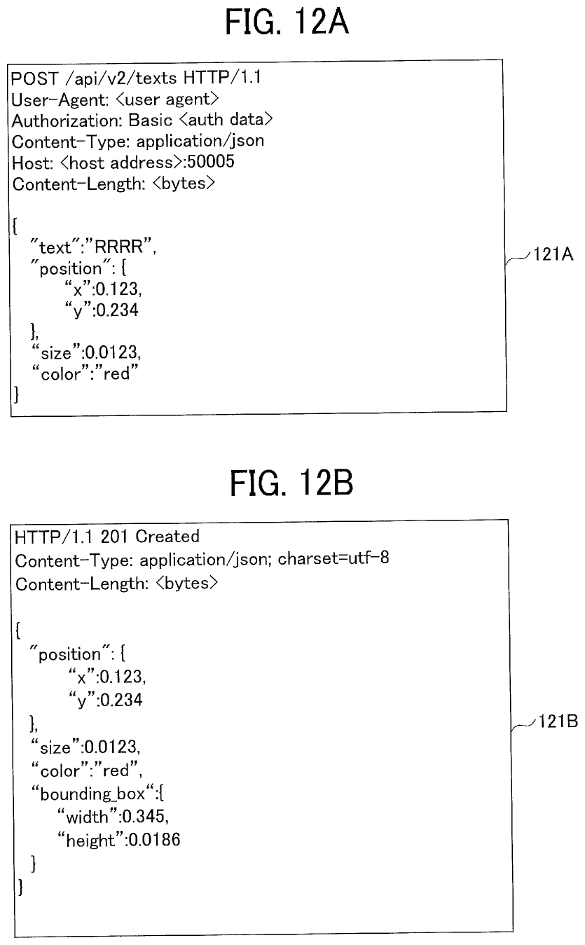

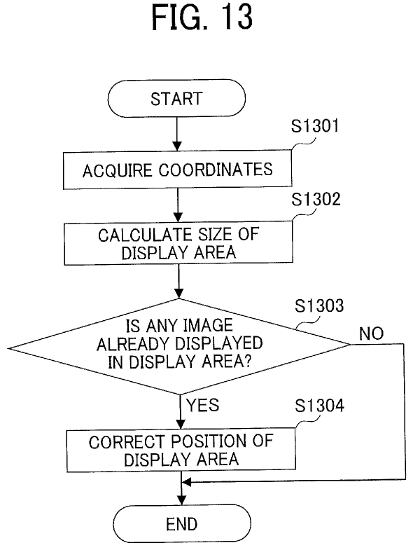

FIGS. 12A and 12B are diagrams illustrating other examples of the HTTP request and the HTTP response transmitted between the management apparatus 300 and the electronic whiteboard 200.

FIG. 12A illustrates a description 121A corresponding to an HTTP request transmitted from the management apparatus 300 to the electronic whiteboard 200 at step S810. FIG. 12B illustrates a description 121B corresponding to an HTTP response transmitted from the electronic whiteboard 200 to the management apparatus 300 at step S811 in response to receipt of the HTTP request.

The description 121A illustrated in FIG. 12A includes the coordinates, the size, and the text data included in the object information.

The process of step S808 in FIG. 8 will be described with FIG. 13. FIG. 13 is a flowchart illustrating a process of the electronic whiteboard 200 of the first embodiment.

In the electronic whiteboard 200 of the first embodiment, the area calculating unit 444 acquires the coordinates included in the object information acquired from the HTTP request (step S1301).

Then, with reference to the size included in the object information, the area calculating unit 444 calculates the size of the display area in the display 280, i.e., the display area for displaying the object on the display 280, with the reference point of the object set to the acquired coordinates (step S1302).

Then, in the electronic whiteboard 200, the position deteiiiiining unit 445 determines whether there is an image already displayed in the calculated display area of the display 280 (step S1303).

If it is determined at step S1303 that there is no image already displayed in the calculated display area (NO at step S1303), the electronic whiteboard 200 completes the process of the position determining unit 445, and proceeds to step S809 in FIG. 8.

If it is determined at step S1303 that there is an image already displayed in the calculated display area (YES at step S1303), the correction unit 446 of the electronic whiteboard 200 corrects the position of the display area in the display 280 (step S1304), and proceeds to step S809 in FIG. 8.

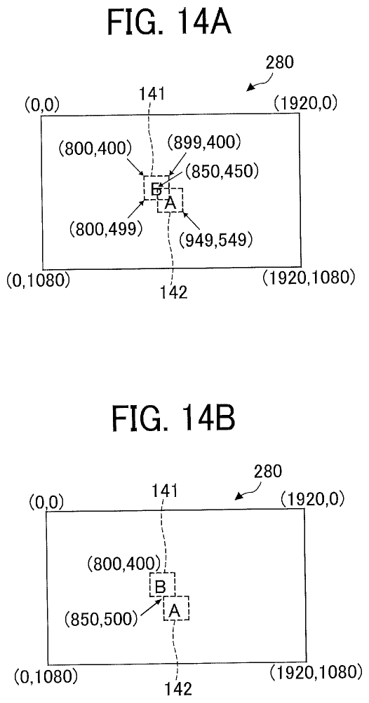

The correction by the correction unit 446 will be described with FIGS. 14A and 14B, FIGS. 15A, 15B, and 15C, and FIGS. 16A, 16B, and 16C. In FIGS. 14A to 16C, the numerical values in parentheses represent X and Y coordinates.

FIGS. 14A and 14B are diagrams illustrating an example of the correction by the correction unit 446 of the electronic whiteboard 200 of the first embodiment. FIG. 14A illustrates an example in which the electronic whiteboard 200 displays an object 142 in response to receipt of a request from the management apparatus 300. Specifically, FIG. 14A illustrates an example in which the object 142 is displayed in the display area calculated from the size of the object 142 and the coordinates (850, 450) of the reference point of the object 142. In this example, a part of an object 141 is already displayed in the display area. Each of the objects 141 and 142 is a square formed with 100 pixels by 100 pixels. However, each of the objects 141 and 142 may be a rectangle. In this case, the object 142 will overlap the object 141. Therefore, the correction unit 446 of the electronic whiteboard 200 corrects the position of the display area of the object 142, i.e., corrects the display position of the object 142 in the display 280.

FIG. 14B illustrates an example in which the display position of the object 142 is corrected by the correction unit 446. In the example of FIG. 14B, the correction unit 446 moves the object 142 to a position below the object 141. Specifically, the correction unit 446 calculates the travel distance of the object 142 as COORD1−COORD2+1. Herein, COORD1 represents the Y-coordinate (i.e., the coordinate in the vertical direction) of the lower side of the already input object (i.e., the object 141), and COORD2 represents the Y-coordinate (i.e., the coordinate in the vertical direction) of the object input with the WebAPI (i.e., the object 142). In the example of FIG. 14B, the coordinates of the reference point (i.e., the upper-left vertex) of the object 141 are (800, 400). Thus, the travel distance of the object 142 after the correction is calculated as 499−450+1=50. Consequently, the coordinates of the reference point of the object 142 after the correction is (850, 500). As illustrated in FIG. 14B, therefore, the object 142 is displayed at a position at which the object 142 will not overlap the object 141.

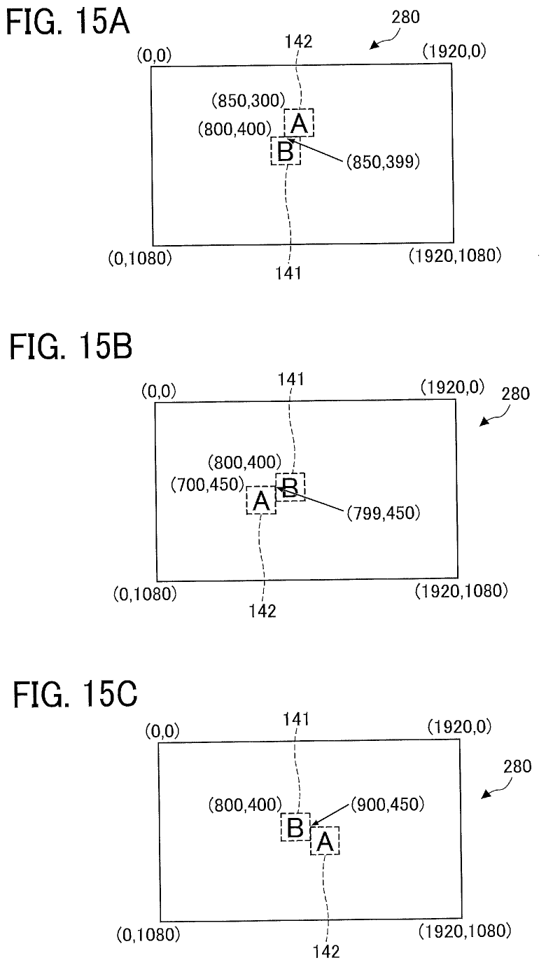

FIGS. 15A, 15B, and 15C are diagrams illustrating other examples of the correction by the correction unit 446 of the electronic whiteboard 200 of the first embodiment.

FIG. 15A illustrates an example in which the object 142 is moved to a position above the object 141. Specifically, the correction unit 446 calculates the travel distance of the object 142 as COORD3−COORD4+1. Herein, COORD3 represents the Y-coordinate (i.e., the coordinate in the vertical direction) of the lower side of the object input with the WebAPI (i.e., the object 142), and COORD4 represents the Y-coordinate (i.e., the coordinate in the vertical direction) of the already input object (i.e., the object 141). Thus, the travel distance of the object 142 after the correction is calculated as 549−400+1=150. Consequently, the coordinates of the reference point of the object 142 after the correction is (850, 300). As illustrated in FIG. 15A, therefore, the object 142 is displayed at a position at which the object 142 will not overlap the object 141.

FIG. 15B illustrates an example in which the object 142 is moved to a position to the left of the object 141. Specifically, the correction unit 446 calculates the travel distance of the object 142 as COORD5−COORD6+1. Herein, COORD5 represents the X-coordinate (i.e., the coordinate in the horizontal direction) of the right side of the object input with the WebAPI (i.e., the object 142), and COORD6 represents the X-coordinate (i.e., the coordinate in the horizontal direction) of the left side of the already input object (i.e., the object 141). Thus, the travel distance of the object 142 is calculated as 949−800+1=150. Consequently, the coordinates of the reference point of the object 142 after the correction is (700, 450). As illustrated in FIG. 15B, therefore, the object 142 is displayed at a position at which the object 142 will not overlap the object 141.

FIG. 15C illustrates an example in which the object 142 is moved to a position to the right of the object 141. Specifically, the correction unit 446 calculates the travel distance of the object 142 as COORD7−COORD8+1. Herein, COORD7 represents the X-coordinate (i.e., the coordinate in the horizontal direction) of the right side of the already input object (i.e., the object 141), and COORD8 represents the X-coordinate (i.e., the coordinate in the horizontal direction) of the left side of the object input with the WebAPI (i.e., the object 142). Thus, the travel distance of the object 142 is calculated as 899−850+1=50. Consequently, the coordinates of the reference point of the object 142 after the correction is (900, 450). As illustrated in FIG. 15C, therefore, the object 142 is displayed at a position at which the object 142 will not overlap the object 141.

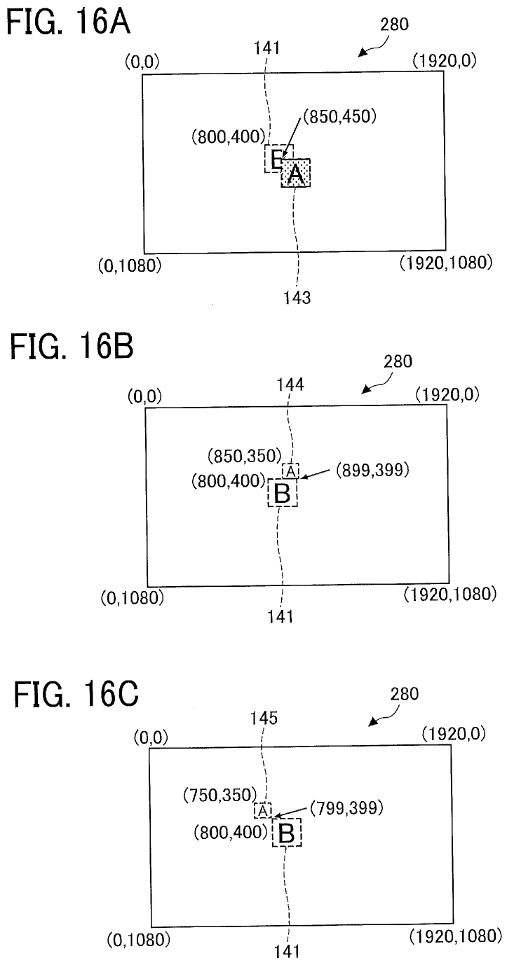

FIGS. 16A, 16B, and 16C are diagrams illustrating other examples of the correction by the correction unit 446 of the electronic whiteboard 200 of the first embodiment.

In FIG. 16A, the position of the object 142 is not corrected. Instead, the object 142 is displayed as a transparent object 143, making both the objects 141 and 143 visible. The transparency level of the object 142 may be set to a desired value.

FIG. 16B illustrates an example in which the object 142 is displayed as an object 144 reduced in size with respect to the vertical direction. Specifically, the correction unit 446 calculates the length in the vertical direction of the object 144 as COORD9−COORDIO. Herein, COORD9 represents the Y-coordinate (i.e., the coordinate in the vertical direction) of the upper side of the already input object (i.e., the object 141), and COORD10 represents the Y-coordinate (i.e., the coordinate in the vertical direction) of the upper side of the object input with the WebAPI (i.e., the object 142). Thus, the length in the vertical direction of the object 144 is calculated as 50 based on an equation 400−450=−50. Consequently, the reduction ratio of the object 144 is 50/100 (i.e., post-reduction length/pre-reduction length), and thus is 0.5 times.

In the first embodiment, the object 142 is thus reduced in size, preventing the objects 141 and 142 from overlapping each other. As illustrated in FIG. 16B, therefore, the object 144 is displayed at a position at which the object 144 will not overlap the object 141.

FIG. 16C illustrates an example in which the object 142 is displayed as an object 145 reduced in size with respect to the horizontal direction. Specifically, the correction unit 446 calculates the length in the horizontal direction of the object 145 as COORD11−COORD12. Herein, COORD11 represents the X-coordinate (i.e., the coordinate in the horizontal direction) of the left side of the already input object (i.e., the object 141), and COORD12 represents the X-coordinate (i.e., the coordinate in the horizontal direction) of the left side of the object input with the WebAPI (i.e., the object 142). Thus, the length in the horizontal direction of the object 145 is calculated as 50 based on an equation 800−850=−50. Consequently, the reduction ratio of the object 145 is 50/100 (i.e., post-reduction length/pre-reduction length), and thus is 0.5 times.

As described above, the correction unit 446 of the electronic whiteboard 200 of the first embodiment performs the correction by moving the object, reducing the size of the object, or changing the transparency level of the object. In the first embodiment, the type of correction performed by the correction unit 446 is individually set for each of the electronic whiteboards 200.

A second embodiment of the present invention will be described below with drawings. The following description of the second embodiment will focus on differences from the first embodiment. Further, functional units of the second embodiment similar to those of the first embodiment will be denoted with the same reference numerals as those used in the first embodiment, and description thereof will be omitted.

The second embodiment is different from the first embodiment in that the object information does not include the coordinates of the reference point.

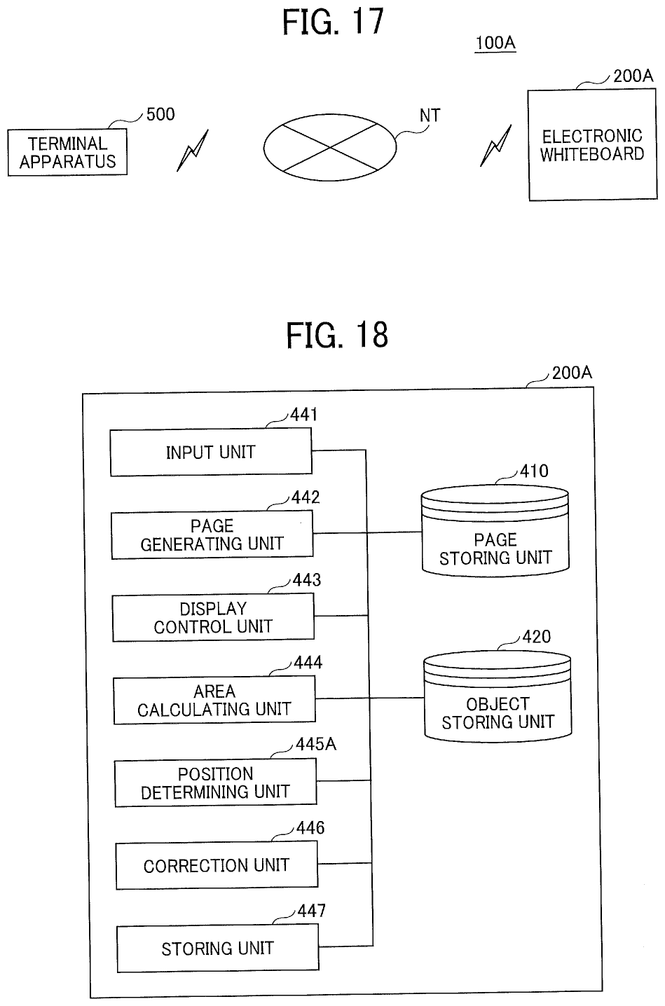

FIG. 17 is a diagram illustrating an example of the system configuration of a display system 100A of the second embodiment. The display system 100A of the second embodiment includes a terminal apparatus 500 and an electronic whiteboard 200A.

In the example of FIG. 17, the apparatuses included in the display system 100A are the terminal apparatus 500 and the electronic whiteboard 200A. However, the apparatuses included in the display system 100A are not limited thereto.

In response to receipt, from the terminal apparatus 500, of an HTTP request that requests the display of data, the electronic whiteboard 200A of the second embodiment searches for an open area in the display 280 of the electronic whiteboard 200A. The electronic whiteboard 200A then displays, in the open area, the object including the requested data.

The terminal apparatus 500 of the second embodiment is used by a user logged in to the display system 100A via the terminal apparatus 500, for example.

In the example of FIG. 17, the display system 100A of the second embodiment is configured to include the terminal apparatus 500 and the electronic whiteboard 200A. However, the display system 100A is not limited to this configuration, and may include a plurality of terminal apparatuses 500, and may include a plurality of electronic whiteboards 200A. Further, the display system 100A may include a projector and an image forming apparatus, for example.

Further, for example, the terminal apparatus 500 of the second embodiment may be an information processing apparatus having a hardware configuration similar to that of the management apparatus 300. Further, the terminal apparatus 500 may be a tablet-type computer or a smartphone, for example.

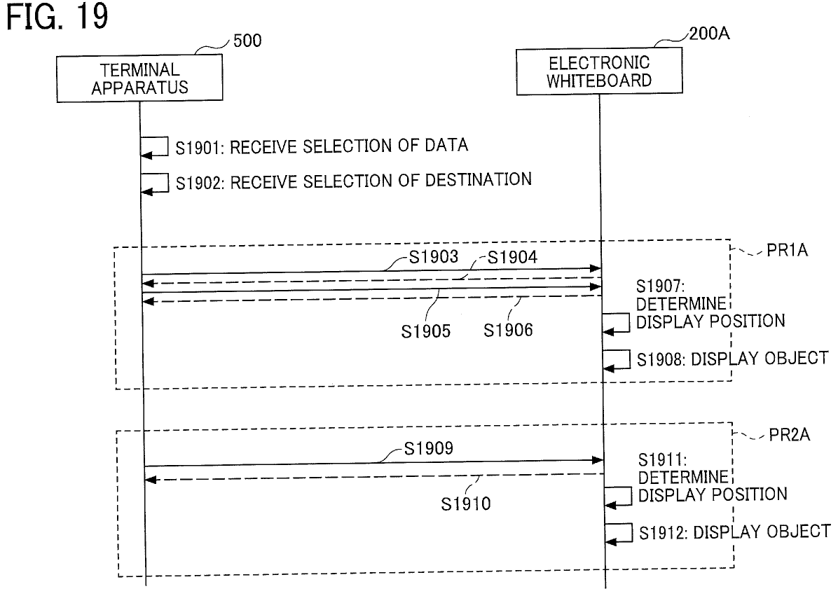

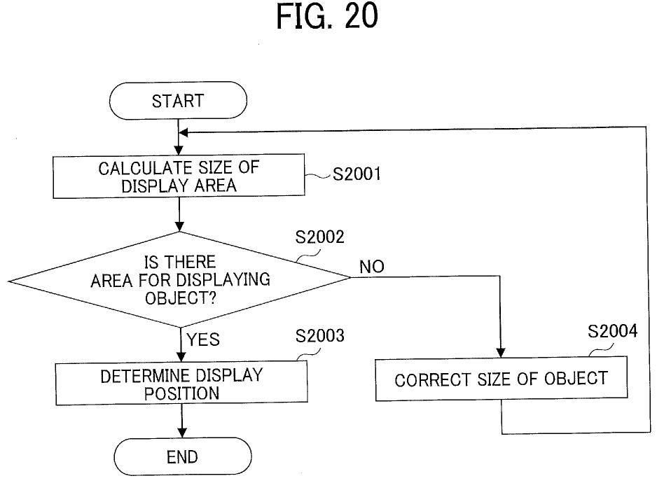

FIG. 18 is a diagram illustrating functions of the electronic whiteboard 200A of the second embodiment. The electronic whiteboard 200A of the second embodiment includes the page storing unit 410, the object storing unit 420, the input unit 441, the page generating unit 442, the display control unit 443, the area calculating unit 444, a position determining unit 445A, the correction unit 446, and the storing unit 447.

In response to receipt of an HTTP request from the terminal apparatus 500, the position determining unit 445A of the second embodiment searches for and determines an area for displaying the object in the display 280. Herein, the area for displaying the object is an area included in the display 280 and having no image displayed therein. That is, the area for displaying the object is an area in the display 280, in which the object displayed on the display 280 will not overlap any information already displayed on the display 280.

An operation of the display system 100A of the second embodiment will be described with FIG. 19.

FIG. 19 is a sequence diagram illustrating an operation of the display system 100A of the second embodiment. In the display system 100A of the second embodiment, the terminal apparatus 500 receives the selection of the data to be transmitted (step S1901), and then receives the selection of the destination apparatus to which the data is to be transmitted (step S1902). It is assumed in the following description that the electronic whiteboard 200A is selected as the destination apparatus to which the data is to be transmitted. Further, although the selection of the data precedes the selection of the destination apparatus in the second embodiment, the selection order is not limited thereto. For example, in the display system 100A, the selection of the data may follow the selection of the destination apparatus.

Then, the terminal apparatus 500 transmits to the selected destination apparatus an HTTP request that requests the display of the object.

If the data selected at step S1901 is the image data, the display system 100A executes an operation illustrated as a process PR1A. If the data selected at step S1901 is the text data, the display system 100A executes an operation illustrated as a process PR2A.

If the data selected at step S1901 is the image data, the terminal apparatus 500 generates an HTTP request including the selected image data and the size of the object including the image data, and transmits the generated HTTP request to the electronic whiteboard 200A (step S1903).

In response to receipt of the HTTP request, the electronic whiteboard 200A transmits an HTTP response to the terminal apparatus 500 as a response to the HTTP request (step S1904). Herein, the HTTP response includes the URI of the upload destination of the object.

In response to receipt of the HTTP response, the terminal apparatus 500 generates an HTTP request that requests the upload of the image data included in the object, and transmits the generated HTTP request to the electronic whiteboard 200A (step S1905). In response to receipt of the HTTP request, the electronic whiteboard 200A transmits to the terminal apparatus 500 an HTTP response representing a processing result (step S1906).

In this step, the storing unit 447 of the electronic whiteboard 200A may acquire the size of the object and the image data from the HTTP request, and may store the size of the object and the image data in the object storing unit 420 as the object information.

Then, with units such as the area calculating unit 444, the position determining unit 445A, and the correction unit 446, the electronic whiteboard 200A determines the display position of the object in the display 280 (step S1907). The process of step S1907 will be described in detail later.

Then, the electronic whiteboard 200A displays the object at the determined display position (step S1908).

If the data selected at step S1901 is the text data, on the other hand, the terminal apparatus 500 generates and transmits an HTTP request to the electronic whiteboard 200A (step S1909). Herein, the HTTP request includes the object including the text data and the size of the object.

In response to receipt of the HTTP request, the electronic whiteboard 200A transmits an HTTP response to the terminal apparatus 500 as a processing result (step S1910). In this step, the storing unit 447 of the electronic whiteboard 200A may acquire the size of the object and the text data from the HTTP request, and may store the size of the object and the text data in the object storing unit 420 as the object information.

The processes of steps S1911 and S1912 are similar to those of steps S1907 and S1908, and thus description thereof will be omitted.

The process of step S1907 in FIG. 19 will be described with FIG. 20.

FIG. 20 is a flowchart illustrating a process of the electronic whiteboard 200A of the second embodiment.

In the electronic whiteboard 200A of the second embodiment, based on the size of the object included in the HTTP request, the area calculating unit 444 calculates the size of the display area for displaying the object on the display 280 (step S2001).

Then, in the electronic whiteboard 200A, the position determining unit 445A determines whether the display 280 has an area for displaying the object (step S2002). Specifically, the position determining unit 445A determines whether the display 280 has an area larger than the display area and having no image displayed therein.

If it is determined at step S2002 that the display 280 has an area larger than the display area and having no image displayed therein (YES at step S2002), the electronic whiteboard 200A determines the coordinates of the reference point of the object (i.e., determines the display position of the object) such that the display area is included in the area (step S2003), and proceeds to step S1908 in FIG. 19.

If it is determined at step S2002 that the display 280 has no area larger than the display area and having no image displayed therein (NO at step S2002), the correction unit 446 of the electronic whiteboard 200A corrects the size of the object (step S2004), and returns to step S2001.

As described above, according to the second embodiment, it is unnecessary to set the position of the reference point of the object when displaying the object on the display 280.

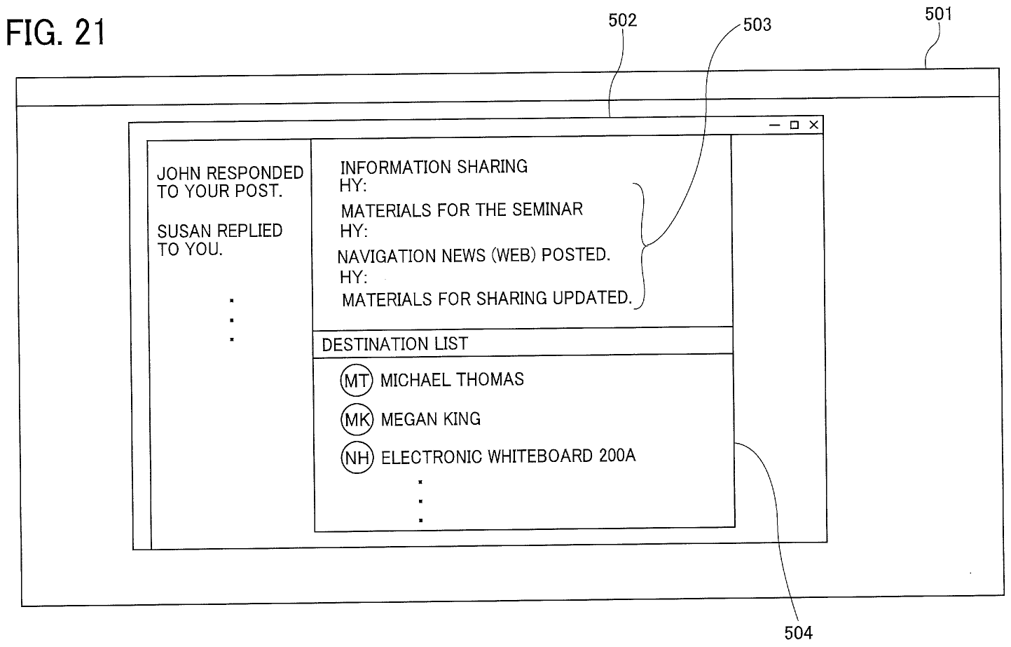

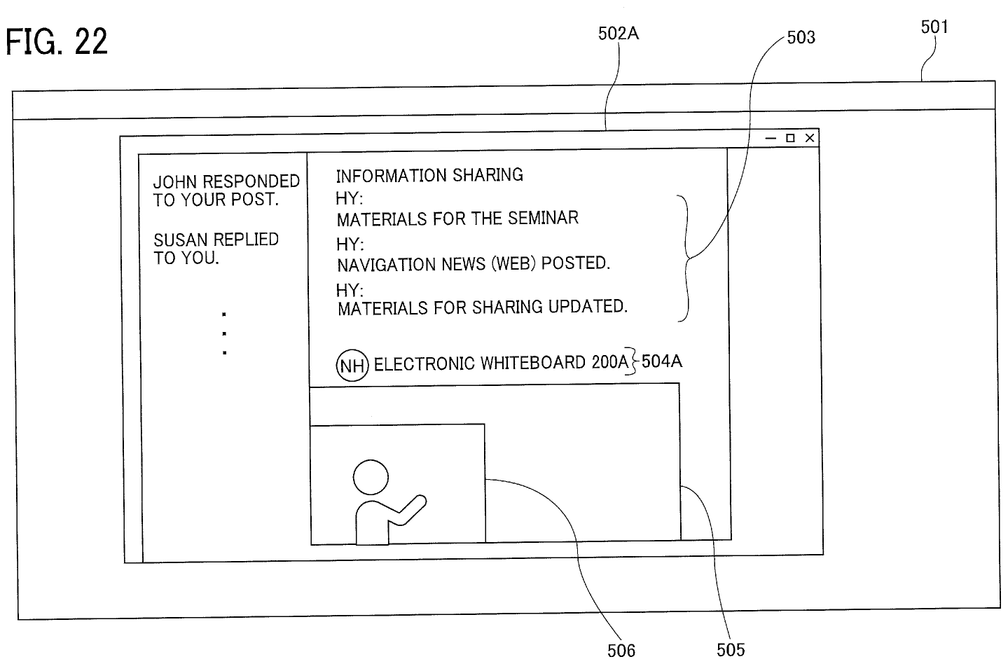

The selection of the data and the selection of the destination apparatus by the terminal apparatus 500 will be described with FIGS. 21 and 22.

FIG. 21 a diagram illustrating an example of display by the terminal apparatus 500 of the second embodiment. A screen 501 illustrated in FIG. 21 is displayed on a display of the terminal apparatus 500, for example.

For example, the terminal apparatus 500 may be installed with an application program for transmitting and receiving text data and image data between grouped users, and the screen 501 may be displayed when the application program is started.

The screen 501 displays a window 502, which displays display fields 503 and 504. The display field 503 displays a history of data exchanges between a user of the terminal apparatus 500 and other users of the display system 100A. The display field 504 display a list of candidates for the data transmission destination.

In the terminal apparatus 500 of the second embodiment, when the data transmission destination is selected from the display field 504, a display field 505 is displayed in a window 502A, as illustrated in FIG. 22. It is assumed here that the electronic whiteboard 200A is selected from the display field 504 as the data transmission destination.

FIG. 22 is a diagram illustrating another example of the display by the terminal apparatus 500 of the second embodiment. In the example of FIG. 22, the window 502A displayed in the screen 501 displays information 504A and the display field 505. The information 504A represents the data transmission destination selected from the display field 504. The display field 505 displays the data to be transmitted to the data transmission destination.

In the window 502A, “ELECTRONIC WHITEBOARD 200A” is displayed as the information 504A representing the data transmission destination, and image data 506 selected as the data to be transmitted is displayed in the display field 505.

When an operation of issuing an instruction to transmit the data is performed in this state, the terminal apparatus 500 of the second embodiment transmits to the electronic whiteboard 200A an HTTP request that requests the display of the image data 506 displayed in the display field 505.

In the second embodiment, the function of the display system 100A may be used as a part of an application program or a social networking service (SNS) used to communicate an intention or information.

With the thus-configured display system 100A, when the user of the terminal apparatus 500, who is scheduled to participate in a meeting using the electronic whiteboard 200A, is going to be late to the start time of the meeting due to traffic conditions, for example, the user is able to directly send a message to the electronic whiteboard 200A from the terminal apparatus 500 to notify that the user is going to be late to the meeting place.

That is, according to the second embodiment, even if the user is at a place away from the electronic whiteboard 200A and thus has difficulty in knowing the display state of the electronic whiteboard 200A, the information transmitted from the terminal apparatus 500 by the user is visibly displayed on the electronic whiteboard 200A.

In the display system 100 of the first embodiment, the management apparatus 300 and the electronic whiteboards 200 communicate with each other. In the display system 100A of the second embodiment, the terminal apparatus 500 and the electronic whiteboard 200A communicate with each other. However, the apparatuses communicate with each other in the display system 100 or 100A are not limited thereto.

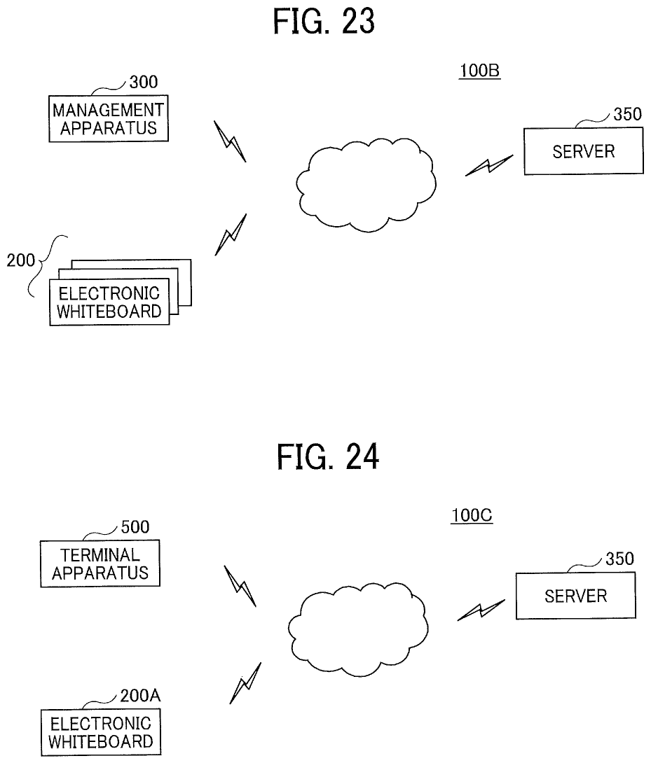

Each of the display systems 100 and 100A may include a server apparatus (also simply referred to as the server). FIG. 23 is a diagram illustrating another example of the system configuration of the display system 100 of the first embodiment. FIG. 23 illustrates a display system 100B including the electronic whiteboards 200, the management apparatus 300, and a server 350. In this case, the management apparatus 300 and the electronic whiteboards 200 may communicate with each other via the server 350.

FIG. 24 is a diagram illustrating another example of the system configuration of the display system 100A of the second embodiment. FIG. 24 illustrates a display system 100C including the electronic whiteboard 200A, the terminal apparatus 500, and the server 350. In this case, the terminal apparatus 500 and the electronic whiteboard 200A may communicate with each other via the server 350.

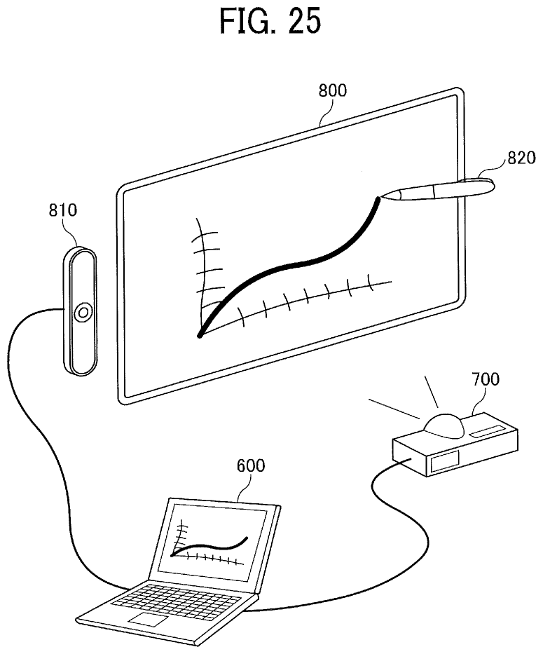

Modified examples of the above-described display system 100C will be described with FIGS. 25 to 27.

FIG. 25 is a diagram illustrating a modified example of the display system 100C. The example of FIG. 25 includes a terminal apparatus 600, an image projector 700, a pen operation detector 810, a screen 800, and an electronic pen 820 in place of the electronic whiteboard 200A and the terminal apparatus 500.

The terminal apparatus 600 is connected by wire to the image projector 700 and the pen operation detector 810.

The image projector 700 projects image data input by the terminal apparatus 600 onto the screen 800 (an example of a display).

The pen operation detector 810 communicates with the electronic pen 820 to detect the operation of the electronic pen 820 in the proximity of the screen 800. Specifically, the electronic pen 820 detects coordinate information representing a point on the screen 800 indicated by the electronic pen 820, and transmits the coordinate information to the terminal apparatus 600.

Based on the coordinate information received from the pen operation detector 810, the terminal apparatus 600 generates stroke image data representing a stroke image input with the electronic pen 820. The terminal apparatus 600 then renders the stroke image on the screen 800 via the image projector 700.

The terminal apparatus 600 further generates page data including superimposed image data representing the image projected by the image projector 700, and transmits the page data to the server 350.

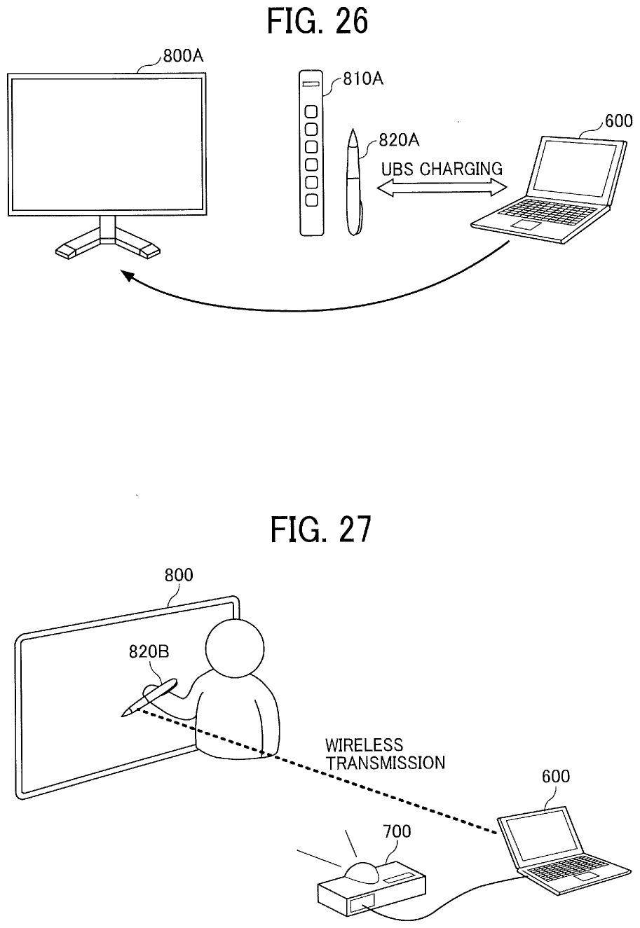

FIG. 26 is a diagram illustrating another modified example of the display system 100C. The example of FIG. 26 includes the terminal apparatus 600, a display 800A, a pen operation detector 810A, and an electronic pen 820A in place of the electronic whiteboard 200A and the terminal apparatus 500.

The pen operation detector 810 is disposed near the display 800A to detect coordinate information representing a point on the display 800A indicated by the electronic pen 820A, and transmits the coordinate information to the terminal apparatus 600. In the example of FIG. 26, the electronic pen 820A may be charged by the terminal apparatus 600 via a USB connector.

Based on the coordinate information received from the pen operation detector 810, the terminal apparatus 600 generates image data of a stroke image input with the electronic pen 820A, and displays the stroke image on the display 800A.

FIG. 27 is a diagram illustrating another modified example of the display system 100C. The example of FIG. 27 includes the terminal apparatus 600, the image projector 700, the screen 800, and an electronic pen 820B in place of the electronic whiteboard 200A and the terminal apparatus 500.

The terminal apparatus 600 wirelessly communicates with the electronic pen 820B in accordance with a standard such as the Bluetooth standard to receive coordinate information of a point on the screen 800 indicated by the electronic pen 820B. Then, based on the received coordinate information, the terminal apparatus 600 generates image data of a stroke image input with the electronic pen 820B, and projects the stroke image on the screen 800 via the image projector 700.

The teiminal apparatus 600 further generates page data including superimposed image data representing the image projected by the image projector 700, and transmits the page data to the server 350.

As described above, the foregoing embodiments are applicable to various system configurations. Further, an embodiment of the present invention provides a display program, which may be distributed as recorded on a computer readable recording medium in an installable or executable file format. The display program causes a computer to execute a display method including determining, in response to receipt of a display request to display an object on a display, whether the object to be displayed on the display will overlap information already displayed on the display, and when the determining determines that the object to be displayed on the display will overlap the information already displayed on the display, correcting a display position of the object in the display.

Further, the apparatuses to which the embodiments are applicable are not limited to the electronic whiteboards 200 and 200A, and may be any display apparatus with a function of operating the object. The embodiments are applicable to apparatuses such as a projector (PJ), an output apparatus such as digital signage, a head-up display (HUD) apparatus, a network-connected household appliance, a connected car, a laptop PC, a mobile phone, a smartphone, a tablet terminal, a gaming device, a personal digital assistant (PDA), and a wearable PC, for example. Further, the apparatuses described in each of the embodiments are illustrative of one of a plurality of computing environments for implementing the embodiment disclosed in the present specification.

According to an embodiment of the present invention, a first apparatus includes a plurality of computing devices such as a server cluster. The plurality of computing devices are configured to communicate with each other via a certain type of communication link such as a network or a shared memory to execute the processes disclosed in the present specification. Similarly, a second apparatus may include a plurality of computing devices configured to communicate with each other.

Further, the first apparatus and the second apparatus may be configured to share the processes of the steps in FIG. 8 in various combinations. For example, one of the processes executed by a particular unit may be executed by the second apparatus. Similarly, the function of a particular unit may be executed by the second apparatus. Further, the components of the first apparatus and the components of the second apparatus may be integrated in one server apparatus, or may be distributed to a plurality of apparatuses.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC), digital signal processor (DSP), field programmable gate array (FPGA), and conventional circuit components arranged to perform the recited functions. The processing circuitry is implemented as at least a portion of a microprocessor. The processing circuitry may be implemented using one or more circuits, one or more microprocessors, microcontrollers, application specific integrated circuits, dedicated hardware, digital signal processors, microcomputers, central processing units, field programmable gate arrays, programmable logic devices, state machines, super computers, or any combination thereof. Also, the processing circuitry may include one or more software modules executable within one or more processing circuits. The processing circuitry may further include memory configured to store instructions and/or code that causes the processing circuitry to execute functions.

If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 101 in a computer system or other system. The machine code may be converted from the source code, etc. If embodied in hardware, each block may represent a circuit or a number of interconnected circuits to implement the specified logical function(s). Further, the above-described steps are not limited to the order disclosed herein.

1. A display apparatus comprising:
circuitry configured to
in response to receipt of a display request to display an object on a display of the display apparatus, determine whether the object to be displayed on the display will overlap information already displayed on the display, and
when it is determined that the object to be displayed on the display will overlap the information already displayed on the display, correct a display position of the object in the display.

2. The display apparatus of claim 1, wherein the display request includes object information including position information and size information, the position information representing the display position of the object in the display, and the size information representing a size of the object, and
wherein the circuitry
calculates a display area of the object in the display based on the position information and the size information,
determines whether the information already displayed on the display is included in the display area, and
when it is determined that the information already displayed on the display is included in the display area, corrects a position of the display area.

3. The display apparatus of claim 2, wherein the circuitry corrects the position of the display area with at least one of a change in the position of the display area and a change in a size of the display area to prevent the object from overlapping the information already displayed on the display.

4. The display apparatus of claim 1, wherein the display request to display the object on the display of the display apparatus is a hypertext transfer protocol request.

5. A display system comprising:
an information processing apparatus; and
at least one display apparatus configured as the display apparatus of claim 1, the at least one display apparatus receiving, from the information processing apparatus, a display request to display an object on a display of the at least one display apparatus.

6. The display system of claim 5, wherein the at least one display apparatus includes a plurality of display apparatuses, and
wherein the display request to display the object on the display of the at least one display apparatus is simultaneously transmitted from the information processing apparatus to the plurality of display apparatuses.

7. A display system comprising:
a terminal apparatus; and
a display apparatus comprising circuitry configured to
in response to receipt, from the terminal apparatus, of a display request to display an object on a display of the display apparatus, determine a display position of the object in the display,
calculate a size of a display area of the object in the display,
when there is information already displayed on the display and the display has an area in which overlapping of the object and the information is avoided, determine a position of the display area of the object in the area, and
when there is information already displayed on the display and the display lacks the area in which the overlapping of the object and the information is avoided, correct the size of a display area of the object.

8. A display method comprising:
in response to receipt of a display request to display an object on a display, determining whether the object to be displayed on the display will overlap information already displayed on the display; and
when the determining determines that the object to be displayed on the display will overlap the information already displayed on the display, correcting a display position of the object in the display.
